(19) United States
(12) Patent Application Publication
(10) Pub. No.: US 2011/0099368 A1
(43) Pub. Date: Apr. 28, 2011

(54) CABLE MODEM AND CERTIFICATE TESTING METHOD THEREOF

(75) Inventor: CHI-FU KOH, Tu-Cheng (TW)

(73) Assignee: HON HAI PRECISION INDUSTRY CO., LTD., Tu-Cheng (TW)

(21) Appl. No.: 12/641,509

(22) Filed: Dec. 18, 2009

(30) Foreign Application Priority Data
Oct. 26, 2009 (CN) 200910308805.1

(51) Int. Cl. H04L 29/06

(52) U.S. Cl. 713/156

(57) ABSTRACT

A cable modem stores certificates including a root certificate authority (CA) certificate, a root CA public key, a manufacturer CA certificate, and a cable modem certificate. The cable modem reads the root CA public key, determines whether the root CA public key complies with a key industry standard, determines whether the manufacturer CA certificate is generated according to the root CA certificate, and determines whether the cable modem certificate is generated according to the manufacturer CA certificate.

### BACKGROUND

1. Technical Field

Embodiments of the present disclosure relate to network devices, and more particularly to a cable modem and a certificate testing method thereof.

2. Description of Related Art

Incorrect important information such as out-of-date or inaccurate certificates and media access control (MAC) addresses may be stored in cable modems during manufacture. Such important information regarding the cable modems needs to be checked.

Presently, additional devices such as cable modem termination systems (CMTSs) and provisioning servers are needed to check such important information of the cable modems, which is inconvenient and provides only limited efficiency.

Therefore, a convenient method for effectively testing important information of the cable modems is needed to overcome the described limitations.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of functional modules of one embodiment of a cable modem in accordance with the present disclosure;

FIG. 2 is a schematic diagram showing a certificate management architecture in accordance with the present disclosure; and

FIG. 3 is a flowchart of one embodiment of a certificate testing method in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

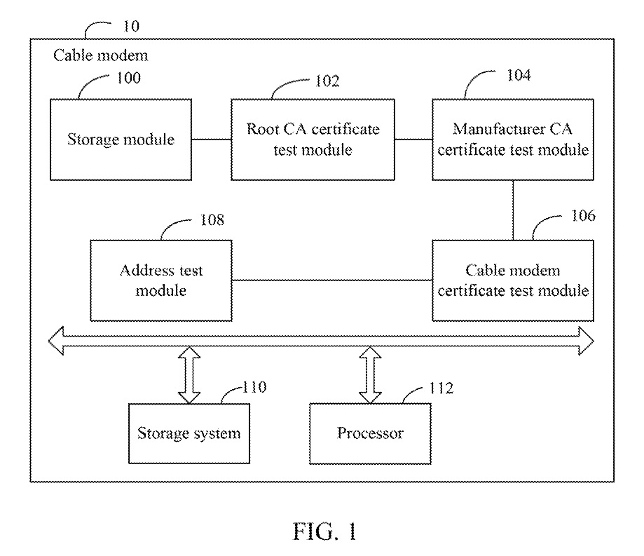

FIG. 1 is a schematic diagram of functional modules of one embodiment of a cable modem 10 in accordance with the present disclosure. In one embodiment, the cable modem 10 includes device information such as certificates and a media access control (MAC) address.

In one embodiment, the cable modem 10 includes a storage module 100, a root certificate authority (CA) certificate test module 102, a manufacturer CA certificate test module 104, a cable modem certificate test module 106, a storage system 110, and at least one processor 112. The modules 100, 102, 104, 106 may include one or more computerized instructions stored in the storage system 110 and executed by the at least one processor 112.

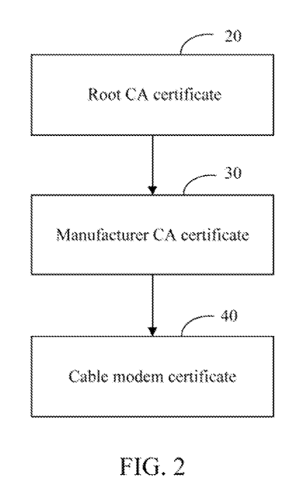

The storage module 100 includes certificates of the cable modem 10. In one embodiment, the certificates include a root CA certificate, a root CA public key, a manufacturer CA certificate, a manufacturer CA public key, a cable modem certificate, a cable modem public key, and a cable modem privacy key. Referring to FIG. 2, the manufacturer CA certificate 30 is generated according to the root CA certificate 20, and the cable modem certificate 40 is generated according to the manufacturer CA certificate 30.

The manufacturer CA certificate includes a first signature value. The cable modem certificate includes a second signature value. The first signature value and the second signature value are digital signatures. The digital signatures are electronic signatures that can be used to ensure that original content of certificates are unchanged.

The root CA certificate test module 102 is operable to read the root CA public key and determine whether the root CA public key complies with a key industry standard. In one embodiment, the key industry standard includes a European key industry standard and an American key industry standard, and accordingly the root CA public key may include a European standard public key and/or an American standard public key. Thus, the root CA certificate test module 102 determines whether all fields of the root CA public key comply with corresponding fields defined by the European key industry standard or the American key industry standard. If all fields of the root CA public key comply with corresponding fields defined by the European key industry standard or the American key industry standard, the root CA certificate test module 102 determines that the root CA public key complies with the key industry standard. If not all fields of the root CA public key comply with corresponding fields defined by the European key industry standard or the American key industry standard, the root CA certificate test module 102 determines that the root CA public key does not comply with the key industry standard. The root CA certificate test module 102 is further operable to report a certificate test failure result when the root CA public key does not comply with the key industry standard.

The manufacturer CA certificate test module 104 is operable to determine whether the manufacturer CA certificate is generated according to the root CA certificate when the root CA public key complies with the key industry standard. In one embodiment, the manufacturer CA certificate test module 104 computes a first checksum value for the manufacturer CA certificate, and decrypts the first signature value of the manufacturer CA certificate via the root CA public key to get a first decrypting value. In one example, the first checksum value may be a secure hash algorithm (SHA-1) checksum value. The manufacturer CA certificate test module 104 further determines whether the first checksum value is the same as the first decrypting value, and determines that the manufacturer CA certificate is generated according to the root CA certificate when the first checksum value is the same as the first decrypting value. The manufacturer CA certificate test module 104 further determines that the manufacturer CA certificate is not generated according to the root CA certificate and reports a certificate test failure result when the first checksum value is different from the first decrypting value.

The cable modem certificate test module 106 is operable to determine whether the cable modem certificate is generated according to the manufacturer CA certificate when the manufacturer CA certificate is generated according to the root CA certificate. In one embodiment, the cable modem certificate test module 106 computes a second checksum value for the cable modem certificate, and decrypts the second signature value of the cable modem certificate via the manufacturer CA public key to get a second decrypting value. In one example, the second checksum value may be an SHA-1 checksum value. The cable modem certificate test module 106 further determines whether the second checksum value is the same as the second decrypting value, and determines that the cable modem certificate is generated according to the manufacturer CA certificate when the second checksum value is the same as the second decrypting value. The cable modem CA certificate test module 106 further determines that the cable modem certificate is not generated according to the manufacturer CA certificate and reports a certificate test failure result when the second checksum value is different from the second decrypting value.

The cable modem certificate test module 106 is further operable to determine whether the cable modem certificate complies with a certificate industry standard when the cable modem certificate is generated according to the manufacturer CA certificate. In one example, the certificate industry standard may be a X.509 standard. The cable modem certificate test module 106 determines whether all fields of the cable modem certificate comply with corresponding fields defined by the certificate industry standard so as to determine whether the cable modem certificate complies with the certificate industry standard. If all fields of the cable modem certificate comply with the corresponding fields defined by the certificate industry standard, the cable modem certificate test module 106 determines that the cable modem certificate complies with the certificate industry standard. If not all fields of the cable modem certificate comply with the corresponding fields defined by the certificate industry standard, the cable modem certificate test module 106 determines that the cable modem certificate does not comply with the certificate industry standard.

The cable modem certificate test module 106 is further operable to determine whether the cable modem public key matches the cable modem privacy key when the cable modem certificate complies with the certificate industry standard. In one embodiment, the cable modem certificate test module 106 encrypts predefined data via the cable modem privacy key, and then decrypts the encrypted predefined data via the cable modem public key. The cable modem certificate test module 106 further determines whether the decrypted predefined data is the same as the predefined data. If the decrypted predefined data is the same as the predefined data, the cable modem certificate test module 106 determines that the cable modem public key matches the cable modem privacy key and accordingly reports a certificate test success result. If the decrypted predefined data is different from the predefined data, the cable modem certificate test module 106 determines that the cable modem public key does not match the cable modem privacy key and accordingly reports a certificate test failure result.

Referring to FIG. 1, the cable modem 10 further includes an address test module 108. The address test module 108 is operable to determine whether MAC addresses of all hardware circuits of the cable modem 10 are continuous. For example, MAC addresses of 00D059AA0131, 00D059AA0132, 00D059AA0133 are continuous. In another example, MAC addresses of 00D059AA0131, 00D059AA0133, 00D059AA0135 are discontinuous. In one embodiment, the cable modem 10 includes a plurality of hardware circuits, such as a USB interface circuit and a wireless local area network (WLAN) interface circuit. Each hardware circuit has a MAC address. The address test module 108 further reports a certificate test failure result when the MAC addresses of all hardware circuits of the cable modem 10 are discontinuous, and reports a cable modem test success result when the MAC addresses of all hardware circuits of the cable modem 10 are continuous.

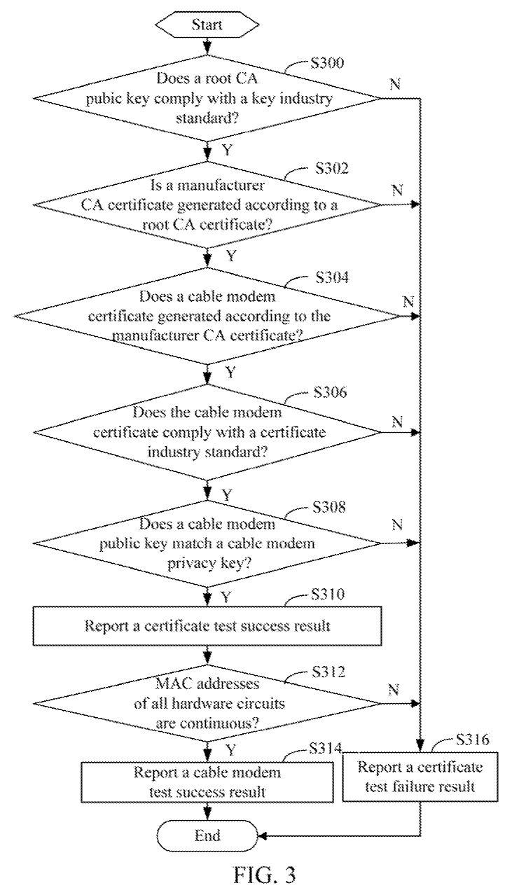

FIG. 3 is a flowchart of one embodiment of a certificate testing method in accordance with the present disclosure. The certificate testing method is executed by the functional modules of FIG. 1. Depending on the embodiment, additional blocks may be added, others deleted, and the ordering of blocks may be changed while remaining well within the scope of the disclosure.

In block S300, the root CA certificate test module 102 reads a root CA public key from the storage module 100 and determines whether the root CA public key complies with a key industry standard. In one embodiment, the root CA certificate test module 102 determines whether all fields of the root CA public key comply with corresponding fields defined by a European key industry standard or an American key industry standard. If all fields of the root CA public key comply with corresponding fields defined by a European key industry standard or an American key industry standard, the root CA certificate test module 102 determines that the root CA public key complies with the key industry standard. If not all fields of the root CA public key comply with corresponding fields defined by a European key industry standard or an American key industry standard, the root CA certificate test module 102 determines that the root CA public key does not comply with the key industry standard.

If the root CA public key does not comply with the key industry standard, in block S316, the root CA certificate test module 102 reports a certificate test failure result.

If the root CA public key complies with the key industry standard, in block S302, the manufacturer CA certificate test module 104 determines whether the manufacturer CA certificate is generated according to the root CA certificate. In one embodiment, the manufacturer CA certificate test module 104 computes a first checksum value for the manufacturer CA certificate, and decrypts the first signature value of the manufacturer CA certificate via the root CA public key to get a first decrypting value. In one example, the first checksum value may be an SHA-1 checksum value. The manufacturer CA certificate test module 104 further determines whether the first checksum value is the same as the first decrypting value, and determines that the manufacturer CA certificate is generated according to the root CA certificate when the first checksum value is the same as the first decrypting value. The manufacturer CA certificate test module 104 further determines that the manufacturer CA certificate is not generated according to the root CA certificate when the first checksum value is different from the first decrypting value.

If the manufacturer CA certificate is not generated according to the root CA certificate, in block S316, the manufacturer CA certificate test module 104 reports a certificate test failure result.

If the manufacturer CA certificate is generated according to the root CA certificate, in block S304, the cable modem certificate test module 106 determines whether the cable modem certificate is generated according to the manufacturer CA certificate. In one embodiment, the cable modem certificate test module 106 computes a second checksum value for the cable modem certificate, and decrypts the second signature value of the cable modem certificate via the manufacturer CA public key to get a second decrypting value. In one example, the second checksum value may be an SHA-1 checksum value. The cable modem certificate test module 106 further determines whether the second checksum value is the same as the second decrypting value, and determines that the cable modem certificate is generated according to the manufacturer CA certificate when the second checksum value is the same as the second decrypting value. The cable modem CA certificate test module 106 further determines that the cable modem certificate is not generated according to the manufacturer CA certificate when the second checksum value is different from the second decrypting value.

If the cable modem certificate is not generated according to the manufacturer CA certificate, in block S316, the cable modem CA certificate test module 106 reports a certificate test failure result.

If the cable modem certificate is generated according to the manufacturer CA certificate, in block S306, the cable modem certificate test module 106 determines whether the cable modem certificate complies with a certificate industry standard. In one example, the certificate industry standard may be a X.509 standard. The cable modem certificate test module 106 determines whether all fields of the cable modem certificate comply with the corresponding fields defined by the certificate industry standard so as to determine whether the cable modem certificate complies with the certificate industry standard. If all fields of the cable modem certificate comply with the corresponding fields defined by the certificate industry standard, the cable modem certificate test module 106 determines that the cable modem certificate complies with the certificate industry standard. If not all fields of the cable modem certificate comply with the corresponding fields defined by the certificate industry standard, the cable modem certificate test module 106 determines that the cable modem certificate does not comply with the certificate industry standard.

If the cable modem certificate does not comply with the certificate industry standard, in block S316, the cable modem certificate test module 106 reports a certificate test failure result.

If the cable modem certificate complies with the certificate industry standard, in block S308, the cable modem certificate test module 106 further determines whether the cable modem public key matches the cable modem privacy key. In one embodiment, the cable modem certificate test module 106 encrypts predefined data via the cable modem privacy key, and then decrypts the encrypted predefined data via the cable modem public key. The cable modem certificate test module 106 further determines whether the decrypted predefined data is the same as the predefined data. If the decrypted predefined data is the same as the predefined data, the cable modem certificate test module 106 determines that the cable modem public key matches the cable modem privacy key. If the decrypted predefined data is different from the predefined data, the cable modem certificate test module 106 determines that the cable modem public key does not match the cable modem privacy key.

If the cable modem public key does not match the cable modem privacy key, in block S316, the cable modem certificate test module 106 reports a certificate test failure result.

If the cable modem public key matches the cable modem privacy key, in block S310, the cable modem certificate test module 106 reports a certificate test success result.

In block S312, the address test module 108 determines whether MAC addresses of all hardware circuits of the cable modem 10 are continuous. In one embodiment, the cable modem 10 includes a plurality of hardware circuits, such as a USB interface circuit and a WLAN interface circuit. Each hardware circuit has a MAC address.

If the MAC addresses of all hardware circuits of the cable modem 10 are discontinuous, in block S316, the address test module 108 reports a certificate test failure result.

If the MAC addresses of all hardware circuits of the cable modem 10 are continuous, in block S314, the address test module 108 reports a cable modem test success result.

In the present disclosure, the certificate testing method does not need additional devices such as cable modem termination systems (CMTSs) and provisioning servers to check the certificates of the cable modems 10, which is convenient and has an improved checking efficiency.

While various embodiments of the present disclosure have been described above, it should be understood that they have been presented using example only and not using limitation. Thus the breadth and scope of the present disclosure should not be limited by the above-described embodiments, but should be defined only in accordance with the following claims and their equivalents.

What is claimed is:

1. A cable modem, comprising:
a storage module operable to store certificates of the cable modem, the certificates comprising a root certificate authority (CA) certificate, a root CA public key, a manufacturer CA certificate, a cable modem certificate, a cable modem public key, and a cable modem privacy key;
a root CA certificate test module operable to read the root CA public key and determine whether the root CA public key complies with a key industry standard;
a manufacturer CA certificate test module operable to determine whether the manufacturer CA certificate is generated according to the root CA certificate when the root CA public key complies with the key industry standard;
a cable modem certificate test module operable to determine whether the cable modem certificate is generated according to the manufacturer CA certificate when the manufacturer CA certificate is generated according to the root CA certificate, and further determine whether the cable modem certificate complies with a certificate industry standard when the cable modem certificate is generated according to the manufacturer CA certificate, determine whether the cable modem public key matches the cable modem privacy key when the cable modem certificate complies with the certificate industry standard, and report a certificate test success result when the cable modem public key matches the cable modem privacy key; and
at least one processor operable to execute the storage module, the root CA certificate test module, the manufacturer CA certificate test module, and the cable modem certificate test module.

2. The cable modem of claim 1, wherein:
the root CA certificate test module is further operable to report a certificate test failure result when the root CA public key does not comply with the key industry standard;
the manufacturer CA certificate test module is further operable to report the certificate test failure result when the manufacturer CA certificate is not generated according to the root CA certificate; and
the cable modem certificate test module is further operable to report the certificate test failure result when the cable modem certificate is not generated according to the manufacturer CA certificate.

3. The cable modem of claim 1, wherein:
the manufacturer CA certificate comprises a first signature value; and
the manufacturer CA certificate test module is further operable to compute a first checksum value for the manufacturer CA certificate, decrypt the first signature value of the manufacturer CA certificate via the root CA public key to get a first decrypting value, determine whether the first checksum value is the same as the first decrypting value; and determine that the manufacturer CA certificate is generated according to the root CA certificate when the first checksum value is the same as the first decrypting value.

4. The cable modem of claim 1, wherein:
the certificates further comprise a manufacturer CA public key and the cable modem certificate comprises a second signature value; and
the cable modem certificate test module is further operable to compute a second checksum value for the cable modem certificate, decrypt the second signature value of the cable modem certificate via the manufacturer CA public key to get a second decrypting value, determine whether the second checksum value is the same as the second decrypting value, and determine that the cable modem certificate is generated according to the manufacturer CA certificate when the second checksum value is the same as the second decrypting value.

5. The cable modem of claim 1, wherein the cable modem certificate test module is further operable to determine whether all fields of the cable modem certificate comply with corresponding fields defined by the certificate industry standard so as to determine whether the cable modem certificate complies with the certificate industry standard.

6. The cable modem of claim 1, wherein the cable modem certificate test module is further operable to encrypt predefined data via the cable modem privacy key, decrypt the encrypted predefined data via the cable modem public key, determine whether the decrypted predefined data is the same as the predefined data, determine that the cable modem public key matches the cable modem privacy key when the decrypted predefined data is the same as the predefined data, and report a certificate test failure result when the decrypted predefined data is different from the predefined data.

7. The cable modem of claim 1, further comprising an address test module operable to determine whether media access control (MAC) addresses of all hardware circuits of the cable modem are continuous, report a certificate test failure result when the MAC addresses of all hardware circuits are discontinuous, and report a cable modem test success result when the MAC addresses of all hardware circuits are continuous.

8. A computer-implemented certificate testing method, comprising:
providing a cable modem comprising a root certificate authority (CA) certificate, a root CA public key, a manufacturer CA certificate, a cable modem certificate, a cable modem public key, and a cable modem privacy key;
reading the root CA public key and determining whether the root CA public key complies with a key industry standard;
determining whether the manufacturer CA certificate is generated according to the root CA certificate if the root CA public key complies with the key industry standard;
determining whether the cable modem certificate is generated according to the manufacturer CA certificate if the manufacturer CA certificate is generated according to the root CA certificate;
determining whether the cable modem certificate complies with a certificate industry standard if the cable modem certificate is generated according to the manufacturer CA certificate;
determining whether the cable modem public key matches the cable modem privacy key if the cable modem certificate complies with the certificate industry standard; and
reporting a certificate test success result if the cable modem public key matches the cable modem privacy key.

9. The certificate testing method of claim 8, further comprising:
reporting a certificate test failure result if the root CA public key does not comply with the key industry standard;
reporting a certificate test failure result if the manufacturer CA certificate is not generated according to the root CA certificate; and
reporting a certificate test failure result if the cable modem certificate is not generated according to the manufacturer CA certificate.

10. The cable modem of claim 8, wherein the manufacturer CA certificate comprises a first signature value.

11. The certificate testing method of claim 10, whether determination of whether the manufacturer CA certificate is generated according to the root CA certificate comprises:
computing a first checksum value for the manufacturer CA certificate;
decrypting the first signature value of the manufacturer CA certificate via the root CA public key to get a first decrypting value;
determining whether the first checksum value is the same as the first decrypting value; and
determining that the manufacturer CA certificate is generated according to the root CA certificate if the first checksum value is the same as the first decrypting value.

12. The certificate testing method of claim 11, wherein the first checksum value is a secure hash algorithm (SHA-1) checksum value.

13. The certificate testing method of claim 8, wherein the certificates further comprise a manufacturer CA public key and the cable modem certificate comprises a second signature value.

14. The certificate testing method of claim 13, whether determination of whether the cable modem certificate is generated according to the manufacturer CA certificate comprises:
computing a second checksum value for the cable modem certificate;
decrypting the second signature value of the cable modem certificate via the manufacturer CA public key to get a second decrypting value;
determining whether the second checksum value is the same as the second decrypting value; and
determining that the cable modem certificate is generated according to the manufacturer CA certificate if the second checksum value is the same as the second decrypting value.

15. The certificate testing method of claim 14, wherein the second checksum value is a SHA-1 checksum value.

16. The certificate testing method of claim 8, wherein determination of whether the cable modem certificate complies with the certificate industry standard comprises:
determining whether all fields of the cable modem certificate comply with corresponding fields defined by the certificate industry standard; and
determining that the cable modem certificate complies with the certificate industry standard if all fields of the cable modem certificate complies with the corresponding fields defined by the certificate industry standard.

17. The certificate testing method of claim 8, wherein determination of whether the cable modem public key matches the cable modem privacy key comprises:
encrypting predefined data via the cable modem privacy key;
decrypting the encrypted predefined data via the cable modem public key;
determining whether the decrypted predefined data is the same as the predefined data;
determining that the cable modem public key matches the cable modem privacy key if the decrypted predefined data is the same as the predefined data; and
determining that the cable modem public key does not match the cable modem privacy key if the decrypted predefined data is different from the predefined data.

18. The certificate testing method of claim 8, further comprising:
determining whether media access control (MAC) addresses of all hardware circuits of the cable modem are continuous;
reporting a certificate test failure result if the MAC addresses of all hardware circuits of the cable modem are discontinuous; and
reporting a cable modem test success result if the MAC addresses of all hardware circuits of the cable modem are continuous.
